(19) United States
(12) Patent Application Publication
(10) Pub. No.: US 2004/0252488 A1
(43) Pub. Date: Dec. 16, 2004

(54) Light-emitting ceiling tile

(75) Inventor: Paul Thurk, Austin, TX (US)

Correspondence Address: Stephen B. Maebius, Foley & Lardner LLP, Washington Harbour, 3000 K Street, N.W., Suite 500, Washington, DC, 20007-5143, US

(73) Assignee: Innovalight

(21) Appl. No.: 10/814,294

(22) Filed: Apr. 1, 2004

Related U.S. Application Data
(60) Provisional application No. 60/458,942, filed on Apr. 1, 2003.

(51) Int. Cl. F21S 8/00; F21V 15/00

(52) U.S. Cl. 362/147

(57) ABSTRACT

Light-emitting ceiling tile device, comprising: a plurality of nanostructures, the nanostructures comprising a group IV semiconductor and a capping agent coupled to the group IV semiconductor, wherein the nanostructures have an average dimension of between about 0.5 nm to about 15 nm; and a first electrode electrically coupled to the plurality of nanostructures; and a second electrode electrically coupled to the plurality of nanostructures; wherein the first and second electrodes together are configured to conduct an applied current to the nanostructures, wherein the nanostructures produce light in response to the applied current.

### RELATED APPLICATIONS

This application claims priority to U.S. provisional application Ser. No. 60/458,942 to P. Thurk filed Apr. 1, 2003, the complete disclosure of which is hereby incorporated by reference in its entirety.

### BACKGROUND

A commercial need exists for improved interior lighting and, in particular, improved ceiling and wall lighting. For example, traditional interior lighting methods using incandescent and fluorescent light bulbs are inefficient and generate too much heat. Electroluminescent and phosphorescent methods can be conceived but have not generally been commercially adopted. For example, solid-state lighting (SSL) based on light emission semiconductor and polymer materials have been tried but at high expense and uncertain reliability. Smart, efficient lighting materials are needed which can be made by inexpensive, commercially viable methods, and which can be commercially adapted for use in existing lighting systems.

Particularly in a commercial setting, ceilings are often made of ceiling tiles or panels (the terms “ceiling tile” and “ceiling panel” are used interchangeably throughout this patent application), and often the ceiling tiles are suspended in a supporting grid system or bonded with use of adhesives. Commercial ceiling tiles are well-known and can be obtained from, for example, Armstrong World Industries, USG Interiors, Kemlite, Tectum, BPB, Celotex, and Chicago Metallic Corp. Other suppliers include Gordon, ProCoat Products, Hunter Douglas, Louvers International, Steel Ceilings, Capaul, and KARP Associates. Economic, decorative, and functional factors are important in commercial sales of ceiling tiles. Beside economic and decorative factors, functional factors which are important include, for example, noise reduction, acoustics, light reflectance, fire code requirements, sag resistance, inhibit spread of mold and mildew, impact resistance, soil and scratch resistance, scrubbability, and/or washability.

Although attempts have been reported at modifying ceiling and wall tiles and panels to incorporate novelty items such as loudspeakers, pictures, and strobe lights, ceiling tiles have not generally been adapted to provide a practical, commercial light source which is seamlessly and intelligently integrated with the ceiling tile. It should be economical, decorative, and functional, a combination of features which is not easy to achieve when moving beyond novelty items. Moreover, ceiling tiles have not generally been adapted to provide light emission properties, particularly wherein the light emission properties are generated from nanostructures such as nanoparticles or nanowires. Nanostructures are becoming increasingly important as part of the burgeoning field of nanotechnology, but their connection to interior lighting ceiling tile applications has to date been underutilized. See, for example, U.S. Pat. Nos. 5,962,863 to Russell et al. (listed assignee: Navy); 6,515,314 to Duggal et al. (listed assignee: General Electric); and 6,501,091 to Bawendi et al (listed assignee: MIT and Hewlett-Packard).

### SUMMARY

The present invention comprises a series of embodiments ranging from ceiling tile sub-assemblies to completed ceiling tiles, and methods of making them. Some of the embodiments are summarized in this non-limiting summary.

In one embodiment, the present invention provides a light-emitting ceiling tile comprising light-emitting group IV nanostructures which preferably are nanoparticles which are preferably silicon nanoparticles, nanocrystals, or quantum dots. The light-emitting group IV nanostructures can be electroluminescent or photoluminescent in nature although the former is preferred. In a preferred embodiment, the ceiling tile comprises a ceiling tile substrate and a light-emitting subassembly disposed on the substrate, the subassembly comprising the group IV nanostructures which preferably are nanoparticles. The ceiling tile substrate can comprise two opposing flat faces and a perimeter, and the light-emitting subassembly can comprise two opposing flat faces and a perimeter. The light-emitting subassembly can comprise a light-emitting layer, wherein the layer comprises the group IV nanostructures which preferably are nanoparticles. The light-emitting layer can comprise a polymer binder including a binder which is electrically conductive. The ceiling tile can comprise layers such as insulation layers, electron barrier layers, or hole barrier layers. If desired, the ceiling tile can emit white light. The ceiling tile can be adapted to provide contact with a voltage source.

In another embodiment, the present invention provides a subassembly for use in a light-emitting ceiling tile, the subassembly comprising light-emitting group IV nanostructures which preferably are nanoparticles.

In another embodiment, a light-emitting ceiling tile device is provided, comprising: a plurality of nanostructures, the nanostructures comprising a group IV semiconductor and a capping agent coupled to the group IV semiconductor, wherein the nanostructures have an average dimension of between about 0.5 nm to about 15 nm; and a first electrode electrically coupled to the plurality of nanostructures; and a second electrode electrically coupled to the plurality of nanostructures; wherein the first and second electrodes together are configured to conduct an applied current to the nanostructures, wherein the nanostructures produce light in response to the applied current. The nanostructures are preferably nanoparticles.

In another embodiment, the present invention provides a light-emitting ceiling tile device, comprising: a plurality of nanoparticles, the nanoparticles comprising a group IV semiconductor and a capping agent coupled to the group IV semiconductor, wherein the nanoparticles have an average particle diameter of between about 0.5 nm to about 15 nm; and a first electrode electrically coupled to the plurality of nanoparticles; and a second electrode electrically coupled to the plurality of nanoparticles; wherein the first and second electrodes together are configured to conduct an applied current to the nanoparticles, wherein the nanoparticles produce light in response to the applied current.

In another embodiment, the present invention provides a light-emitting ceiling tile device, comprising: a plurality of nanowires, the nanowires comprising a group IV semiconductor and a capping agent coupled to the group IV semiconductor, wherein the nanowires have an average diameter of between about 0.5 nm to about 15 nm; and a first electrode electrically coupled to the plurality of nanowires; and a second electrode electrically coupled to the plurality of nanowires; wherein the first and second electrodes together are configured to conduct an applied current to the nanowires, wherein the nanowires produce light in response to the applied current.

The present invention further provides the method of making a light-emitting ceiling tile comprising combining a ceiling tile substrate with a light-emitting subassembly comprising light-emitting group IV nanostructures, which preferably are nanoparticles, so that the subassembly is disposed on the ceiling tile substrate.

Also provided is the method of making a light-emitting subassembly comprising combining (a) a light-emitting layer comprising light-emitting group IV nanostructures, (b) first and second electrodes, and (c) first and second electrical insulation layers, wherein the layers (a), (b), and (c) are in laminar arrangement, wherein the first electrode is disposed on the first electrical insulation layer, and the first electrode and the first electrical insulation layer are transparent.

Advantages of the present invention are many and include improved efficiency and compatibility with existing commercial ceiling tile methods. Additional advantages are discussed in the detailed description section.

### BRIEF DESCRIPTION OF THE DRAWINGS

FIG. 1 illustrates a perspective view of a sub-assembly which comprises a light-emitting layer surrounded by electrode layers and electrical insulation layers.

FIG. 2 illustrates a perspective view of a ceiling tile substrate.

FIG. 3 illustrates the ceiling tile from below, the inset showing the sub-assembly disposed on a ceiling tile substrate. The sub-assembly comprises insulation, cathode, light-emitting, transparent conductor, and transparent insulation layers.

FIG. 4 illustrates the ceiling subassembly and layers therein.

FIG. 5 illustrates another view of the layered ceiling tile which is fit into the supporting structure.

FIG. 6 shows an organic LED device having a single organic layer with phosphor nanoparticles dispersed therein.

FIG. 7 shows a schematic illustration of one non-limiting example of an illumination device in accordance with the invention. The device includes an LED as a primary light source coated with a layer of phosphor materials.

### DETAILED DESCRIPTION

I. Ceiling Tile and Electroluminescent Devices Introduction

Examples of patents and patent publications in the field of ceiling tiles include: U.S. Pat. Nos. 6,397,531 to Martin; 6,389,771 to Moller; 6,117,514 to Herrmann; 6,068,907 to Beauregard; 4,330,691 to Gordon; and Patent Publication 2002/0152704 to Thompson et al. Other patents include, for example, U.S. Pat. Nos. 6,701,686 to Platt; 4,642,951 to Mortimer; 6,698,543 to Golterman; 6,693,512 to Frecska; and 6,669,158 to Masas. These include the materials used to make ceiling tiles, the shapes of ceiling tiles, and the methods of supporting them.

Electroluminescent and light-emitting devices are known in the art including, for example, U.S. Pat. Nos. 4,769,292 to Tang et al.; 5,126,214 to Tokailin et al; 5,294,870 to Tang et al.; 5,683,823 to Shi et al.; 5,717,289 to Tanaka; 5,813,753 to Vriens et al.; 5,943,354 to Lawandy et al.; 5,998,803 to Forrest et al.; and 6,252,254 to Soules et al.

These references can be used in the practice of the present invention.

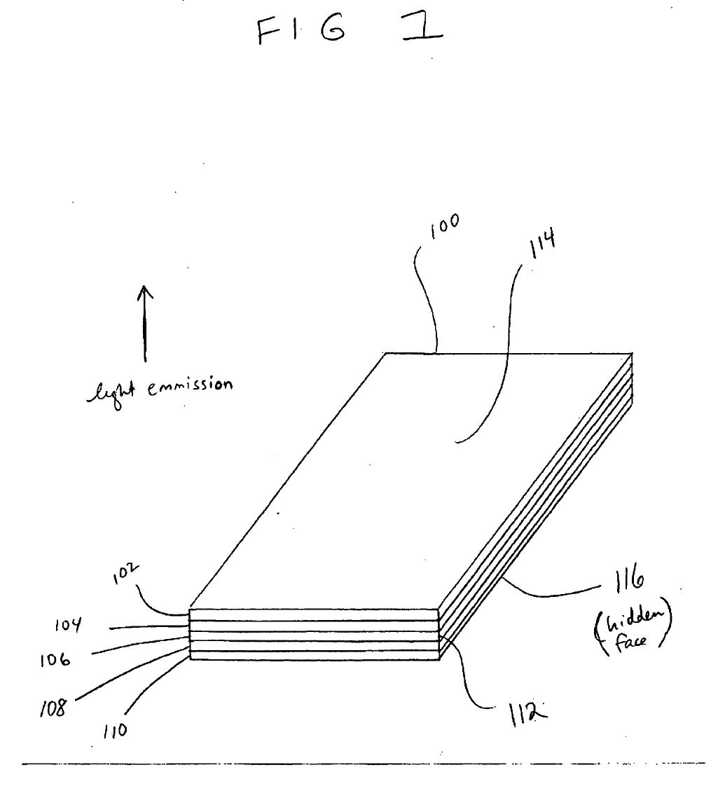

II. Sub-Assembly Preferred Embodiment: FIG. 1

FIG. 1 illustrates a preferred embodiment of the present invention, which is a five layer embodiment. 100 represents the light-emitting subassembly comprising multiple layers in a generally laminar arrangement. 102 represents a first electrical insulation layer. 104 represents a first electrode layer. Layer 104 can be disposed on and generally laminar with the first electrical insulation layer 102. 106 represents a light-emitting layer comprising group IV nanostructures. Layer 106 can be generally laminar with and disposed on the first electrode layer 104. 108 represents a second electrode layer, different from the first electrode layer, and 110 represents a second electrical insulation layer different from the first electrical insulation layer. Layer 108 can be generally laminar with and disposed on the light-emitting layer 106, and layer 110 can be generally laminar with and disposed on the second electrode layer 108. In one embodiment, 108 can be a cathode, and 104 can be an anode. Cathodes and anodes can be multi-layered if desired such as, for example, a bi-layer cathode or a bi-layer anode. The first and second electrode layers can sandwich the light-emitting layer 106. In turn, the first and second insulation layers can further sandwich a multi-layer structure comprising light-emitting layer and first and second electrode layers.

FIG. 1 illustrates 5 layers but additional layers can be used as desired. For example, electrodes can be multi-layer electrodes. Layers can be introduced to improve the light emitting properties. The invention is not particularly limited to five layer subassemblies. For example, the ceiling tile or subassembly can further comprise one or more electron transport and/or hole transport layers which can be coupled to the first and second electrode layers (e.g., cathode and anode, respectively). For example, a conjugated polymer such as poly(phenylene vinylene) (PPV) can be doped to be an electron transport layer or a hole transport layer. Known methods can be used to reduce the electron-injection barrier height between cathode and electron transport layer. Known methods also can be used to balance the injection rates of holes and electrons including hole blocking materials. Electron barrier layers can be used in, for example, the subassembly as described in, for example, U.S. Pat. Nos. 5,073,805 to Nomura; 5,142,343 to Hosokawa; and 5,536,949 to Hosokawa. Hole barrier layers can be used in, for example, the subassembly as described in, for example, U.S. Pat. Nos. 5,073,805 to Nomura; 5,516,577 to Matsuura; and 6,660,410 to Hosokawa. Known electroluminescent device materials can be used including, for example, LiF, Alq3, TAZ, TPD, and PEDOT. Two layer and three-layer devices can be fabricated for light emission. Also, the light-emitting ceiling tile or subassembly can further comprise a reflective layer to help direct emitted photons out of the device (nanostructures such as nanoparticles can emit light isotropically). For example, reflectivity can be designed into one or more electrodes including the cathode.

112 represents a perimeter comprising edges and comers for the subassembly. The subassembly 100 can be generally planar or tile-like in shape and characterized by a length and a width which are much greater than the height. 114 represents an inner face which is generally planar and is designed for facing the interior of a room or public area and passing light from the emitting layer 106 through the first electrode layer 104 and through the first insulation layer 102 to the interior. 116 (hidden) represents an outer face which can be generally flat and opposes the inner face and is coplanar therewith. The outer face 116 is generally adapted for matching with a ceiling tile substrate. For example, it can be flat for matching with a flat ceiling tile substrate.

The perimeter 112 typically can have a first pair of opposite edges and a second pair of opposite edges when the ceiling tile subassembly is in a square or rectangular configuration.

The thickness of the light-emitting subassembly is not particularly limited. In general, it should be thin and robust enough to allow for rolling, handling, packaging, and facile attachment to the ceiling tile substrate. The thickness can be, for example, about 100 nm to about 2 mm. The thickness can be, for example, about 25 nm to about 5 microns, or more particularly about 50 nm to about 1,000 nm, and more particularly, about 50 nm to about 200 nm. Support structures can be used, if desired.

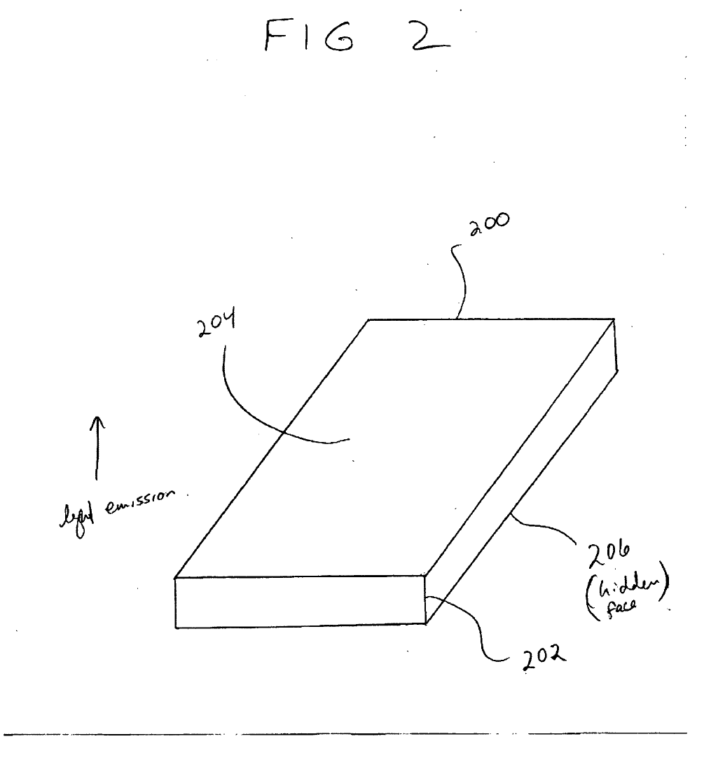

III. Ceiling Tile Substrate—FIG. 2

The ceiling tile substrate, which can be used in combination with the light-emitting subassembly, is not particularly limited. Numerous commercial and conventional ceiling tiles can be used having decorative and functional patterns. In general, they are preferably light weight and inexpensive. FIG. 2 further illustrates a preferred embodiment, having a generally rectangular shape. 200 represents a ceiling tile substrate. 202 represents a perimeter comprising corners and edges. 204 represents an outer face, and 206 represents an inner face (hidden). In general, the length and width of the ceiling tile substrate will be greater than the height, and the lengths and widths can be at least one foot. In general, flat, relatively planar structures are desired. One face of the ceiling tile substrate, e.g., face 204, is designed to allow for the light-emitting subassembly to be disposed on the substrate. For example, the outer face 116 of the substrate can be adapted for placing on the face 204. This means, for example, that the ceiling tile substrate face is flat and can be matched with a flat outer face and bonded by conventional mechanical or chemically adhesive means.

In a typical example, the ceiling tile substrate can be designed to be an acoustical ceiling tile substrate. In a typical example, the subassembly and the ceiling tile can be designed to have approximately the same length and width so as to form one integral piece when combined. In general, flame retardant materials can be used. In general, the sub-assembly can be flexible enough to work with a wide range of commercial, known ceiling tiles of different materials, functions, styles, and configurations.

The perimeter 202 typically can have a first pair of opposite edges and a second pair of opposite edges when the ceiling tile substrate is in a square or rectangular configuration.

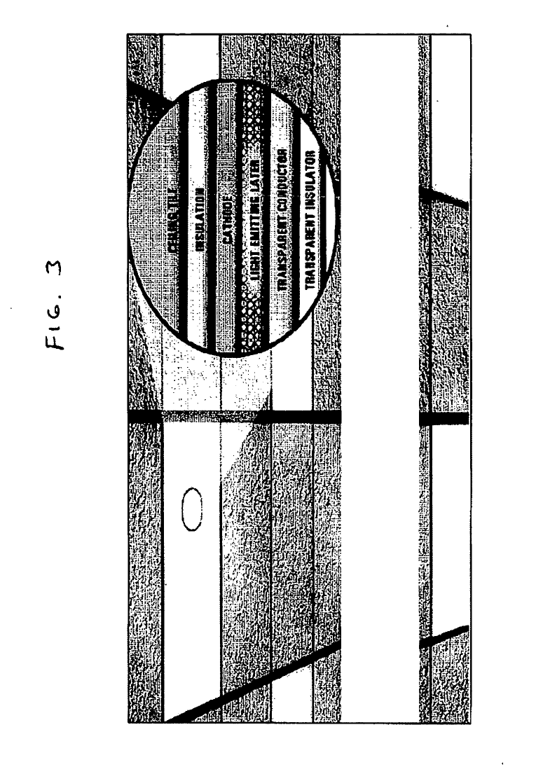

IV. FIGS. 3-5

The light-emitting subassembly can be combined with the ceiling tile substrate as illustrated in, for example, FIG. 3, which shows the layering of ceiling tile, insulation, cathode, light-emitting layer, transparent conductor, and transparent insulator in the inset. FIG. 3 also shows how light-emitting ceiling tiles can be used in conjunction with non-light-emitting ceiling tiles in a grid like fashion with a grid support system.

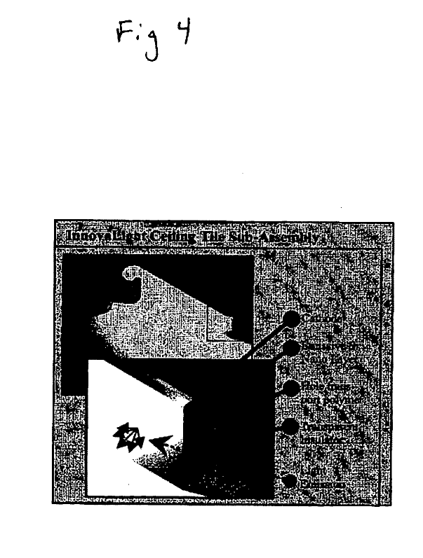

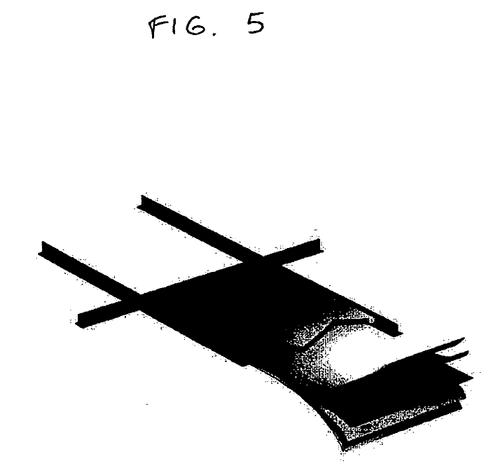

FIGS. 4 and 5 further illustrate the layering effect, light emission, and the support system.

The assembled light-emitting ceiling tile can be designed for interlocking fit including tongue and groove designs. Conventional ceiling tile designs can be used including attachment systems, furring strips, track and clip systems, and high strength adhesives.

In a preferred embodiment, the light-emitting sub-assembly is used in conjunction with a commercial ceiling tile which does not need further adaptation for use with the light-emitting sub-assembly.

V. Nanostructures and Methods of Making

The light-emitting group IV nanostructures can have a form which provide quantum confinement effects which can be exploited with electrical stimulation to cause light emission. The effects can vary with the size of the nanostructure. For example, the emitted color of an individual nanostructure can vary with the size of the nanostructure. Examples of nanostructures include nanoparticles and nanowires, including group IV nanoparticles and group IV nanowires. Other examples include nanocrystals and quantum dots. Although the present invention is not generally limited by the methods of making the nanostructures, the nanostructures are preferably prepared by continuous methods, amenable to scale-up.

The fundamental principles, devices, and practical applications of light emitting materials are extensively described in, for example, Phosphor Handbook (Ed., S. Shionoya, and W. Yen), CRC, 1999. For example, chapter 9 describes “Electroluminescence Materials” (pages 581-600) and is incorporated by reference.

Nanostructures can have at least one dimension such as average diameter which is about 100 nm or less, more particularly about 50 nm or less, more particularly about 10 nm or less. For example, the dimension can be about 0.5 nm to about 15 nm, or about 0.1 nm to about 10 nm. In particular, nanoparticles can have average particle diameters of about 100 nm or less, more particularly about 50 nm or less, more particularly about 10 nm or less. Nanowires can have average wire diameters of about 100 nm or less, more particularly about 50 nm or less, more particularly, about 10 nm or less, but lengths extending for one or more microns up to, for example, about 10 microns. In general, a nanoscale dimension is at least about 1 nm or more. Structures and dimensions less than 100 nm are particularly preferred. One preferred range is about 0.5 nm to about 15 nm; another preferred range is about 0.1 nm to about 10 nm. For example, the average nanoparticle diameter can be about 0.5 nm to about 15 nm, or about 0.1 nm to about 10 nm.

Once nanostructures are synthesized, they can be separated, selected, and blended as desired to provide the desired lighting effect. For example, blends of nanostructures can be used to prepare white light emitting layers. Colored emission can be also desired including red, orange, yellow, green, blue, and violet, and combinations thereof.

Preferred group IV nanostructures comprise silicon, germanium, or a combination thereof, including alloys and epicoated structures, as well as in certain cases organic capping ligands around the perimeter of the nanostructures. Silicon nanostructures can be used. The nanostructure can comprise at least about 90 atomic percent, preferably substantially 100 atomic percent, of the group IV element. If desired, the nanostructures can be doped including both n and p types of doping. Crystalline silicon nanostructures are preferred.

The light emitting nanostructures, including the nanoparticles, can be luminescent including electroluminescent or photoluminescent. In some cases, the nanostructures and nanoparticles can be considered to be phosphors. For example, phosphor materials capable of emitting high CRI light may be made by employing a phosphor material made up of a collection of luminescent, whether electroluminescent or photoluminescent, semiconductor nanoparticles having a polydisperse size distribution.

In preferred embodiments, the nanoparticle can have an average diameter between about 1 nm to 100 nm and may, in some instances, include elongated particle shapes, such as nanowires, in addition to more spherical, triangular or square particles. Nanoparticles have an intermediate size between individual atoms and macroscopic bulk solids. Nanoparticles typically have a size on the order of the Bohr exciton radius (e.g. 4.9 nm for silicon), or the de Broglie wavelength, of the material, which allows individual nanoparticles to trap individual or discrete numbers of charge carriers, either electrons or holes, or excitons, within the particle. The spatial confinement of electrons (or holes) by nanoparticles is believed to alter the physical, optical, electronic, catalytic, optoelectronic and magnetic properties of the material. The alterations of the physical properties of a nanoparticle due to confinement of electrons are generally referred to as quantum confinement effects.

Nanoparticles may exhibit a number of unique electronic, magnetic, catalytic, physical, optoelectronic and optical properties due to quantum confinement effects. For example, many nanoparticles exhibit luminescent effects, whether electroluminescent effects or photoluminescence effects, that are significantly greater than the luminescence effects of macroscopic molecules having the same composition. Additionally, these quantum confinement effects may vary as the size of the nanoparticle is varied.

Group IV semiconductor nanoparticles, including silicon nanoparticles, germanium nanoparticles, and SiGe alloy nanoparticles, Si or Ge cores comprising another inorganic coating, or nanoparticles doped with impurities are particularly well suited for use in the ceiling tiles described herein. Group IV semiconductor nanoparticles offer several advantages over other semiconductor nanoparticles. First, the Group IV semiconductor nanoparticles, such as Si and Ge, are non-toxic (see further description below on safety). This makes materials made from these semiconductors attractive for commercial production. In contrast, Group II-VI semiconductors, such as CdS or CdSe, and Group III-V semiconductors, such as InAs and GaAs, are toxic materials which are strictly regulated, making these nanoparticles less desirable for use in commercial devices. Additionally, the ionic nature of the bonding in compound semiconductors, such as Group II-VI semiconductors, renders these materials much less chemically stable than Group IV semiconductors. Thus, materials made from Group IV nanoparticles will have longer lifetimes than similar materials made from compound semiconductors. Silicon also has a lower electron affinity than Group II-VI systems. Therefore, silicon has a lower barrier to hole injection, which increases the chances of electron-hole recombination. Finally, the emission characteristics of Group IV semiconductors makes these materials ideally suited for use as white light light emitters and phosphors. Relative to other semiconductor materials, Group IV semiconductors luminesce, whether electroluminesce or photoluminesce, with a rather wide spectrum. In particular, silicon nanoparticles provide fairly broad and overlapping emission profiles. This is advantageous for white light emitters and phosphors because it enables a collection of Group IV nanoparticles having a polydisperse size distribution to emit a relatively smooth distribution of light across the visible spectrum using a single photoexcitation source, making them attractive candidates for broadband lighting.

As noted above, the Group IV nanoparticles may be core/shell nanoparticles having a Si or Ge core coated with an inorganic shell. In some such embodiments, the inorganic shell is composed of a wider bandgap semiconductor, such as ZnS or CdS. In other embodiments the core (e.g. Si) is coated with a smaller bandgap semiconductor (e.g. Ge). Such core/shell nanoparticles may be made by adapting processes that have been used to produce larger core/shell particles or those used to produce core/shell nanoparticles for other material systems. Specific examples of such are formation of silicon/silicon nitride core/shell nanoparticles produced in a gas-phase pyrolysis method (see R. A. Bauer, J. G. M. Becht, F. E. Kruis, B. Scarlett, and J. Schoonman, J. Am. Ceram. Soc., 74(11), pp.2759-2768 (November 1991), the entire disclosure of which is incorporated herein by reference) and wet-chemical formation of cadmium selenide/zinc sulfide core/shell nanoparticles (see B. O. Dabbousi, J. Rodriguez-Viejo, F. V. Mikulec, J. R. Heine, H. Mattoussi, R. Ober, K. F. Jensen, and M. G. Bawendi, J. Phys. Chem. B, 101(46), pp.9463-9475, (1997), the entire disclosure of which is incorporated herein by reference.

The electroluminescent nanoparticles or photoluminescent nanoparticles may desirably be surface treated with organic or inorganic passivating agents that prevent reactive degradation of the nanoparticles when exposed to water and oxygen or other chemical contaminants. Particularly suitable organic passivating agents, or “capping agents”, are described in U.S. patent application Ser. No. 2003/0003300; Nano Letters, 2, 681-685 (2002); and J. Am. Chem. Soc., 123, 3743-3748 (2001), which are incorporated herein by reference. Other suitable passivating agents and their production are described in J. M. Buriak, Chemical Reviews, 102(5), pp. 1271-1308 (2002). Organic passivating agents include, but are not limited to, alcohols, alkenes, alkynes, thiols, ethers, thioethers, phosphines, amines, amides, carboxylates, sulfonates, or quaternary ammonium compounds. Nanoparticles passivated with monolayers of these passivating agents are able to emit with relatively short (e.g. nanosecond scale or even sub-picosecond scale) lifetimes and high quantum yields.

A variety of methods for producing semiconductor nanoparticles, including Group IV nanoparticles are known. These methods include, solution, gas, plasma and supercritical fluid based approaches. U.S. Patent Application No. US 2003/0003300 and J. Am. Chem. Soc., vol. 123, pp. 3743-3748 (2001) describe supercritical fluid-based approachs for making various semiconductor nanoparticles of a selected size. The entire disclosures of both of these references are incorporated herein by reference. Other suitable methods for producing Group IV nanoparticles (quantum dots) are presented in U.S. Pat. No. 6,268,041, in U.S. Patent Application Publication No. 2003/0066998, and in Huisken, et al., Adv. Mater., 14 (24), p. 1861 (2002), the entire disclosures of which are incorporated herein by reference. A plasma based synthesis for producing Si and Ge nanoparticles of controlled size in a continuous flow reactor if described in Gorla, et al., J. Vac. Sci. Technol. A., 15(3), pp. 860-864 (1997), the entire disclosure of which is incorporated herein by reference.

Alternatively, the nanoparticles may be produced in situ, as by conventional epitaxial growth processes. For example, a core-shell structure may be produced by first growing nanocrystals of a first semiconductor material, such as germanium, on a substrate, such as a silicon substrate, using well known lithographic techniques and subsequently growing an epitaxial layer of a second semiconductor material, such as silicon around the nanocrystals. Techniques for the epitaxial growth of various semiconductor materials, including chemical vapor deposition (CVD) are well-known in the art.

Silicon nanoparticles may also be formed using a deconstructive approach, such as by etching from a bulk silicon wafer, followed by ultrasonic exposure and separation of the nanoparticles by different sizes. Suitable etch-based methods from producing nanoparticles may be found in Properties of Porous Silicon, Leigh Canham Ed.; INSPEC (1997), ISBN 0852969325, pp. 3-29; Heinrich, et al., Science, 255, pp. 66-68 (1992); Belomoin, et al., Appl. Phys. Lett., 77(6), p. 779-781 (2000); and Belomoin, et al., Appl. Phys. Lett., 80(5), p. 841-843 (2002), the entire disclosures of which are incorporated herein by reference.

Light-emitting group IV nanoparticles are still further described in various prior art literature. For example, they are described in, for example, U.S. Patent Publications 2003/0003300 A1 to Korgel et al, published Jan. 2, 2003 and 2003/00334486 to Korgel et al., published Feb. 20, 2003 (“the Korgel patent publications”), which are hereby incorporated by reference in their entirety. These publications, for example, describe the size, morphology, passivation, and optical properties of the nanoparticles.

Still further, the materials and methods of U.S. Pat. No. 6,268,041 to Goldstein can be used if desired and is hereby incorporated by reference in its entirety.

Group IV nanowires are described in, for example, the following publications, which are hereby incorporated by reference in their entirety:

(a) Lu, Hanrath, Johnston, and Korgel, NanoLetters, 2003, Vol. 3, No. 1, pgs. 93-99 (“Growth of Single Crystal Silicon Nanowires in Supercritical Solution from Tethered Gold Particles on a Silicon Substrate”).

(b) Holmes, Johnston, Doty, Korgel, Science, 287, Feb. 25, 2000, pages 1471-1473 (“Control of Thickness and Orientation of Solution-Grown Silicon Nanowires”).

(c) Hanrath, Korgel, J. Am. Chem. Soc., Vol. 124, No. 7, 2002, pages 1424-1429 (“Nucleation and Growth of Germanium Nanowires Seeded by Organic Monolayer-Coated Gold Nanocrystals”).

Desirable properties of the nanostructures include size tunable luminescence (e.g., for silicon, about 1 or 2 nm diameter emits blue, whereas about 5-6 or 8 nm diameter emits red), promising efficiencies, temperature independent luminescence, constant degradation across the crystal diameter, chemically stable and robust, high sensitivity to surface states, 1:1 lattice match with bulk silicon for silicon nanostructures, unique charging behavior, printability, and ability to use in non-planar devices.

VI. Light Emitting Layer

The light-emitting layer can be made with use of known film, including thin film, organic and inorganic layering methods. Electroluminescent and photoluminescent layers can be designed and built by methods known in the art. For example, the Korgel publications describe light-emitting devices and light-emitting layers (for example, paragraphs 137-144 in US 2003/0003300 A1 and claims 217-268 therein) and are hereby incorporated by reference. In particular, paragraph 141 describes production of white light. FIG. 5 illustrates use of a first electrode, a second electrode, and a substrate to provide for light emission. Light-emitting devices are further described in, for example, U.S. Pat. No. 5,977,565 (listed assignee: Toshiba). A photoluminescent system in combination with an electroluminescent system is described in Duggal et al., U.S. Pat. No. 6,515,314, which is hereby incorporated by reference in its entirety.

The light-emitting layer can comprise multiple emitting layers. In one embodiment, for example, a primary electroluminescent layer can be used such as a light-emitting polymer or a small molecule OLED. This primary layer can photopump another layer comprising, for example, phosphors to achieve white light. For example, white light embodiments are described in another U.S. patent application filed concurrently herewith, Apr. 1, 2003, provisional application Ser. No. 60/458,941, “PHOSPHOR MATERIALS AND ILLUMINATION DEVICES MADE THEREFROM,” to Paul Thurk, which is hereby incorporated by reference and serves as a priority document to U.S. regular application Ser. No. ______ to Paul Thurk and David Jurbergs filed Apr. 1, 2004 which is also hereby incorporated by reference in its entirety. White light embodiments are particularly preferred which have high color rendering indices, preferably at least 75 and more preferably at least 85. The primary layer can also emit light, contributing directly to light output, in addition to photopumping.

The group IV nanostructures can be used in conjunction with one or more additional components to improve the material properties of the light-emitting layer. For example, the electrical conductivity of the layer can be adjusted as desired. Blends and composite layers can be used. Inorganic and organic components can be used. Small molecule, macromolecule, and solid-state molecular components can be used. For example, binders and encapsulants can be used including conductive binders, non-conductive binders, light-emitting binders, and polymer binders. In a preferred embodiment, the nanostructures, both nanoparticles and nanowires, can be in a polymer matrix. Specifically, the light-emitting layer can comprise a polymer binder for the light-emitting group IV nanostructures. In many embodiments, the polymer binder can be selected to provide flexible films and layers. For photoluminescent properties, the binder can be selected differently from electroluminescent properties.

Examples of polymer binders include polystyrenes, polyimides, epoxies, acrylic polymers, polyurethanes, and poly carbonates. Inorganic binders include, for example, silica glasses, silica gels, and silicone polymers.

The nanoparticles may be dispersed in a polymeric binder by mixing the nanoparticles, the binder and optionally an appropriate solvent and/or dispersants. Suitable solvents include high vapor pressure organic solvents, such as cyclohexane, hexane, toluene or xylene, which may be easily removed once the dispersion have been formed into a coating, film or layer. The mixture may then be dried, hardened, cured or otherwise solidified to provide a dispersion of nanoparticles in a solid host matrix of binder. In some embodiments, the binder takes the form of polymerizable monomers or oligomers that are polymerized after mixing with the nanoparticles. An exemplary method for dispersing nanoparticles in a epoxy binder is described in U.S. Pat. No. 6,501,091, the entire disclosure of which is incorporated herein by reference.

Inks can be used. Known coating and layering methods can be used including use of solvents and viscosity adjustment components. In general, binders can be used which provide relatively low or tunable viscosity. The colors of the different light-emitting components can be designed to provide white light. For example, a red light-emitting polymer could be used with a blue or green light-emitting nanostructure. Also, for example, a blue light-emitting polymer could be used with a green, yellow, orange, and/or red light-emitting nanostructure. Blue organic emission, for example, can be coupled with nanoparticle emission to generate white light. When different light-emitting materials are used together, their selection can be compatible with respect to parameters such as break-down voltage and drive current.

The amount of the group IV nanostructures in the layer 106 can be varied to provide the desired lighting, materials, and processing properties. For example, the amount can be, for example, about 1 wt. % to about 50 wt. %, and more particularly, about 2 wt. % to about 25 wt. %.

The binder can be, for example, polymeric and can be a commercially available binder commercially used for luminescent nanoparticles, whether photoluminescent nanoparticles or electroluminescent nanoparticles, such as, for example, epoxy, silicone, nitrocellulose, cyanoethyl cellulose, cyanoethyl pullulan, polyvinylidene fluoride, polyethylene oxide, polyethylene, polypropylene, polytetrafluoroethylene, polyacrylates, and mixtures and copolymers thereof. The binder can help to further encapsulate and prevent moisture and oxygen entry to the light-emitting nanostructures. The amount of binder can be selected to provide the desired material properties. The binder can be electrically conductive and can be, for example, an electrically conductive polymer, whether doped or undoped. It can be, for example, greater than 50 wt. % in the light-emitting layer.

Ordered distributions of nanostructures can be used to achieve the desired color effects, e.g., generate white light.

Known processing methods can be used and are not particularly limited. For example, the nanostructures can be deposited in layer form by additive printing methods including, for example, screen printing or ink jet printing. Ink jet printing can provide better control and higher throughput. Screen printing can be used with higher viscosity solutions. For example, screen printing of OLEDs is described in U.S. patent publication 2002/0167024, published Nov. 14, 2002, to Jabbour et al. Formation of thin film layers can be carried out by methods described in, for example, Marc J. Madou, Fundamentals of Microfabrication, The Science of Miniaturization, 2^{nd} Ed., 2002, Chapter 3. For example, silk-screening or screen printing is described on pages 154-156 with use of inks and pastes. Other methods include, for example, spin coating, spray coating, dip coating, and roller coating. Application can be carried out on the transparent first electrode layer.

The thickness of the light-emitting layer is not particularly limited but can be, for example, about 4 nm to about 1 mm, more particularly, about 50 nm to about 100 microns, and more particularly, about 100 nm to about 50 microns. The light-emitting layer can be sufficiently thin to be a monolayer of nanoparticles, wherein the thickness of the layer is approximately the diameter of the nanoparticle. In general, the layer can be a continuous layer although non-continuous layers having separated regions of light-emitting nanostructures can be used as desired. These regions can be red, green, and blue domains, that can be modulated to change the color of the light from white, to any other color in the spectrum.

In addition, in the making of light emitting layers, the following patents to Bawendi also can be used if desired and are hereby incorporated by reference in their entirety: U.S. Pat. No. 6,251,303; U.S. Pat. No. 6,501,091; and U.S. Pat. No. 6,322,901, as well as Published Application US 2001/0040232. The following Alivisatos patents also can be used if desired and are hereby incorporated by reference in their entirety: U.S. Pat. No. 5,537,000; U.S. Pat. No. 5,990,479; U.S. Pat. No. 6,423,551. Another patent on light emitting nanocrystals is U.S. Pat. No. 5,882,779 to Lawandy.

VII. Electrical Contacts and Electrode Materials

Electrodes 104 and 108 can be used to provide electrical contact with and energize the light-emitting group IV nanostructures. The ceiling tile or the subassembly can be adapted to provide contact with a voltage source. For example, the electrodes can be connected to a voltage source using known mechanical and chemical means to provide conduction including, for example, pins, foils, terminals, spring clips, electrical contacts, conductive grease, and conductive adhesives such as conductive epoxy. The voltage source can be, for example, part of the ceiling tile support structure. Voltage can be applied to support structures including, for example, supporting T-bar structures. Known support structures can be used and an advantage of the invention is the ability to use known structures, so long as they can conduct electricity. Examples include aluminum supports. Wiring can be integrated into conductive crossbars such as aluminum crossbars. Electrical contacts can be used for other functionality as well including, for example, audio speakers. Technology is known and can be used in the present invention for combinations of ceiling tile with external electrical inputs such as audio speakers in panel or tile-like structures: see for example U.S. Pat. Nos. 4,923,032 to Nuernberger (Ceiling Tile Sound System) and 6,215,881 to Azima et al. (Ceiling Tile Loud Speaker).

The first electrode layer 104, e.g., the anode layer, can inject positive charge carriers into the light-emitting layer when an electrical voltage is applied. The anode layer can be made of a metal having a high work function; e.g., greater than about 4.5 eV, preferably from about 4.5 eV to about 5.5 eV. Indium tin oxide (ITO) can be used for this purpose. The thickness of the anode layer can be, for example, about 25 nm to about 400 nm, preferably from about 50 nm to about 200 nm. The first electrode layer can be substantially transparent to light transmission and can allow at least 80% light transmitted therethrough. Therefore, light emitted from the layer 106 can escape through the first electrode without being seriously attenuated. Other materials suitable for use as the first electrode layer include, for example, tin oxide, indium oxide, zinc oxide, indium zinc oxide, aluminum oxide, gold, silver, composite coatings, metal nanocrystal or carbon nanotube doped polymers, and mixtures thereof. Materials can be selected in composition and thickness to provide the desired combination of electrical conductivity and optical transparency.

The second electrode layer 108, e.g., the cathode, can inject negative charge carriers (electrons) into the light emitting layer 106 when a voltage is applied. It can be selected from a material having a low work function; e.g., less than about 4 eV. Materials suitable for use as a cathode include, for example, K, Li, Na, Mg, La, Ce, Ca, Sr, Ba, Al, Ag, In, Sn, Zn, Zr, or mixtures thereof. Preferred materials for the manufacture of cathodes include Ag—Mg, Al—Li, In—Mg, and Al—Ca alloys. The thickness of the second electrode layer can be, for example, about 25 nm to about 500 nm, preferably from about 50 nm to about 200 nm.

In determining appropriate work functions for the electrodes, the breakdown voltage of the nanostructures can be considered.

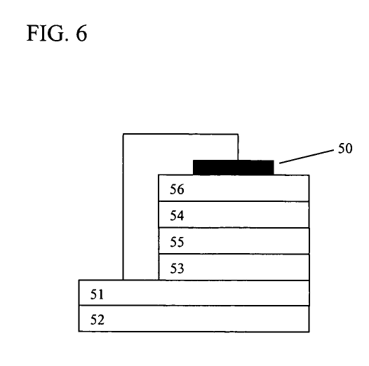

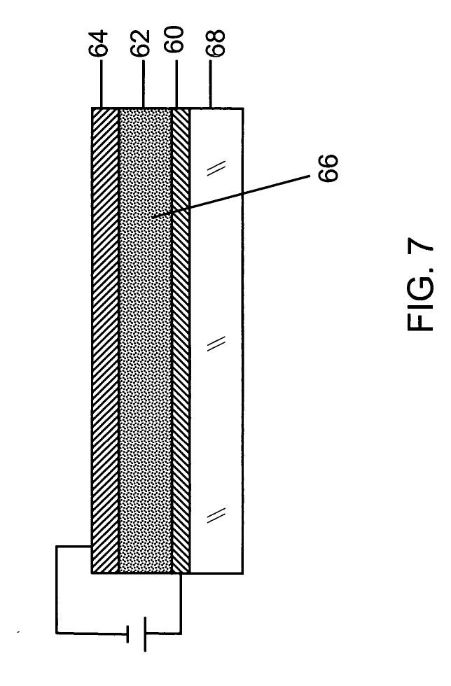

VIII. FIGS. 6 and 7

Additional embodiments are provided in FIGS. 6 and 7.

In another embodiment the illumination device may have an organic light emitting diode (OLED) type structure, as shown in FIG. 6. In an OLED, organic films are sandwiched between two charged electrodes, one a metallic cathode 50 and one a transparent anode 51, such as ITO, optionally disposed atop a transparent substrate 52, such as glass. The organic films consist of a hole-transport layer 53, an electroluminescent emissive layer 54, a photoluminescent emissive layer 55, and an electron-transport layer 56. Alternatively, layer 55 may be positioned between layers 53 and 51, may be positioned between layers 51 and 54, or may be combined with or embedded in layer 52. Both the electron transport layer and the hole transport layer may be made of a doped polymeric material, such as poly(phenylene vinylene). Other layers that may optionally be incorporated into the OLED structure include, a hole injection layer, an electron injection layer and a hole blocking layer. When voltage is applied to the OLED, the injected positive and negative charges recombine in the electroluminescent emissive layer to create a primary light source. Light from this primary light source then acts to photopump the photoluminescent emissive layer. In this configuration, the phosphor particles of the type described herein may be embedded in the photoluminescent emissive layer and the electroluminscent emissive layer may be made of any suitable electroluminescent light emitting organic material. In a variation of this embodiment, the electroluminescent emissive layer may have blue or UV light emitting electroluminescent nanoparticles, e.g. Group IV nanoparticles of the type described herein, dispersed or embedded therein. When an OLED is employed as a primary light source, it may be advantageous to use a device having a broad emissive area which dissipates heat better, increasing the longevity of illumination devices made therefrom.

Alternatively, the transport layers and the electroluminescent and photoluminescent emissive layers could be combined into a single organic layer made from an electroluminescent polymer having a plurality of phosphor particles dispersed therein. In this configuration, shown in FIG. 7, an anode layer 60 injects positive charge carriers into the organic layer 62 and the cathode layer 64 injects negative charge carriers into the organic layer 62 when a voltage is applied across the OLED. The positive and negative charges then recombine in the organic layer to provide a primary light. Some or all of this primary light is absorbed by the phosphor particles 66 dispersed in the organic layer. These particles then emit a secondary light. As shown in the figure, the anode layer is optionally disposed atop a transparent substrate 68.

Materials for making the various layers in an OLED device are known. For example, the anode may be made of ITO, tin oxide, indium oxide, zinc oxide, indium zinc oxide, aluminum oxide, gold, silver, or composite coatings, such as metal nanocrystal coatings or carbon nanotube doped polymers. Generally, the anode materials will be selected to provide the desired combination of electrical conductivity and optical transparency. Suitable cathode materials include, for example, K, Li, Na, Mg, La, Ce, Ca, Sr, Ba, Al, Ag, In, Sn, Zn, Zr, or mixtures thereof. Preferred materials for the manufacture of cathodes include Ag—Mg, Al—Li, In—Mg, and Al—Ca alloys. Tris(8-hydroxyquinolato) aluminum (Alq3) may be used as an electron-transporting material. 3-phenyl-4-(1f-naphthyl)-5-phenyl-1,2,4-triazole (TAZ) may be used as a hole blocking material. N, N′-bis(3-methylphenyl)-N, N′-diphenylbenzidine (TPD) may be used as a hole transport material. Poly-3,4-ethylenedioxythiophene (PEDOT) is a conductive polymer that may be used as a hole injection material. A more detailed description of suitable materials for the electroluminescent organic layer, the anode and the cathode is provided in U.S. Pat. No. 6,515,314, the entire disclosure of which is incorporated herein by reference.

IX. Electrical Insulation Layers

The electrical insulation layers are not particularly limited in composition so long as the first insulation layer 102 provides sufficient transparency. The first electrical insulation layer and the first electrode layer can be substantially transparent to the light emitted by the light-emitting layer. High dielectric constant materials can be used such as, for example, barium titanate, dispersed in polymeric binder such as those noted above for the light-emitting layer. The electrical insulation layers can have a thickness of, for example, about 50 nm to about 500 nm, preferably from about 50 nm to about 200 nm.

In addition to the first and second electrical insulation layers, one or more additional electrical insulation layers can be also used to help prevent shorting between the electrodes or provide a moisture or oxygen barrier. Specifically, the light-emitting sub-assembly can further comprise an insulation layer which protects the group IV nanostructures from water and oxygen.

The ceiling tiles and the support system can be adapted so the clearance between the tile and the support system is sufficiently large to allow installation and removal and the clearance is also sufficiently small so that the tile, once installed, cannot take a skew position in the support system. Standard tile sizes can be used such as, for example, 2×2 feet or 2×4 feet.

X. Advantages

Advantages of the present invention include improved efficiency. In addition, the ceiling tiles can be easily moved around the room, changing the lighting configuration. The ceiling tiles can easily be put into place in any given spot to attain electrical connection. Expensive fluorescent fixtures and installations can be avoided. The ceiling tiles can be dimmable, unlike most current fluorescent fixtures, which generally can require a different, especially complicated and expensive ballast to make them dimmable. This attribute allows users, such as commercial buildings, to dim overhead lights at night. This provides the requisite emergency illumination for emergency indoor lighting, but at a reduced cost. This application has a low flux requirement. Emergency indoor lighting can also be a useful application of the present invention, particularly when the lumens requirement of the emergency lighting are not as high as for use in non-emergency lighting. Other applications with lower flux requirements including track lighting, and airplanes including airplane ceiling tiles can be carried out. The tile can change color depending on the time of day and lighting ranging from, for example, dawn, mid-day, and dusk.

In particular, the group IV nanostructures, including nanoparticles and nanowires, have a variety of properties which make them suitable for ceiling tile applications. They operate in a wide temperature and humidity range and can be stored on a shelf for years without degradation. They have promising efficiencies, fast turn-ons, cool operation, and high color tunability. In addition, they have a high color-rendering index, matching the color quality of an incandescent bulb and exceeding that of fluorescent bulbs. The nanostructures have a 1:1 lattice match with bulk silicon, which uniquely enables them in some cases to integrate with inexpensive silicon-based drive circuitry for “smart lights.” In general, it does not take much material to coat the ceiling tile substrate. For example, good results can be achieved with only about one to about 30 mg nanoparticles per square foot of ceiling tile substrate, or about 10 mg to about 15 mg of nanoparticles per ceiling tile substrate. Upon coating, only about a 15 wt. % gain is found for existing ceiling tile substrates. Hence, conventional ceiling tile cross supports can be used.

In addition, environmental and safety factors can be an advantage. For example, fluorescent tubes comprise mercury. Many new solid-state lighting technologies, including II-VI and III-V systems, require toxic materials such as mercury, cadmium, arsenic, selenium, and the like. And existing devices generate extreme heat that can cause burns. When evacuated glass packages are used with conventional incandescent and fluorescent lights, dangerous glass shrapnel can result from breakage or implosion. The embodiments described herein do not have any of these safety considerations.

Another advantage is flexibility. For example, the nanostructures can be passivated individually so that stable nanostructures can be blended with a flexible polymer. Many competing technologies require that passivation be done at a larger device level which reduces the ability to provide flexibility.

Another advantage is fewer heat management issues. For example, it may be advantageous to use a device having a broad emissive area which dissipates heat better, increasing the longevity of illumination devices made therefrom.

Finally, the light emitting embodiments described herein utilize a single material to reach all wavelengths of the visible spectrum. Most other solid-state lighting systems need two or more different material systems to reach the spectrum. A single material has the advantage of being able to utilize one common set of drive electronics for light emission across the colors. It also has the advantage of having a constant degradation schedule across the different colors. This avoids harmful differential aging that can shift the color of the device over time.

Electroluminescent devices may also be employed as a primary light source. In their simplest form, these devices include an emissive layer sandwiched between an anode and a cathode. The emissive layer spontaneously emits light when placed in an electric field. Typically, the emissive layer includes ZnS particles, dispersed in a binder. These devices emit light in the blue and green regions of the visible spectrum. Other electroluminescent materials, including Group II-VI and Group III-V particles may also be used. Depending on the exact nature of the emissive layer, electroluminescent devices based on these materials may emit light at a variety of wavelengths including blue light, green light, blue-green light and UV light. Suitable electroluminescent devices for use as primary light sources in the illumination devices provided herein are known. These include the electroluminescent light emitting devices described in U.S. Pat. Nos. 6,406,803 and 5,537,000 and in U.S. Patent Application Publication Nos. 2002/0153830 and 2003/0042850, the entire disclosures of which are incorporated herein by reference. When an electroluminescent device is employed as a primary light source, it may be advantageous to use a device having a broad emissive area which dissipates heat better, increasing the longevity of illumination devices made therefrom.

Group IV semiconductor nanoparticles of the type described herein may also be used to form the emissive layer in an electroluminescent device. For example, an electroluminescent device may include a plurality Group IV semiconductor nanoparticles dispersed in a binder and coated onto a first conductive layer, such as an indium tin oxide (ITO) layer, with a second conductive layer, such as a evaporated aluminum layer, disposed over the nanoparticle dispersion. The first conductive layer optionally may be disposed on a transparent substrate, such as a polyester substrate. The wavelength at which the electroluminescent device emits will depend on the voltage applied thereto and on the nature and size distribution of the nanoparticles contained therein.

XI. Other Tile Applications

Finally, a preferred embodiment of the invention is ceiling tiles. Using the above description, other tile applications can be carried out using other tile substrates with many of the advantages noted above, and many different types of tiles are known useful for their structural, functional, and artistic value. The tile substrate can be, for example, ceramic, stone, floor, wall, roofing, clay, porcelain, mosaic, and the like. Tile materials can be metal, ceramic, polymeric, glass, inorganic, organic, composite, and combinations thereof. For example, U.S. Pat. Nos. 6,361,660 and 6,060,026 to Goldstein describe disposing nanocrystals on tiles. Interior light applications are of particular interest, whether for mobile interiors such as airplane or bus interiors or fixed interiors such as housing interiors including, for example, lighting in kitchens, underneath cupboards, and the like. In some applications, lower light intensities are needed which can be of interest when the particular light emitting system does not have high light intensity. For example, some present commercial embodiments on the market have indirect lighting system wherein light is emitted and reflected off of a surface. With the present invention, light can be directly emitted, with no need of a reflection. This direct lighting approach can be useful for airplane and bus interiors in particular.

While the principles of this invention have been described in connection with specific embodiments, it should be understood clearly that these descriptions are made only by way of example and are not intended to limit the scope of the invention.

What is claimed is:

1. A light-emitting ceiling tile comprising light-emitting group IV nanoparticles.

2. The light-emitting ceiling tile according to claim 1, wherein the group IV nanoparticles are silicon nanoparticles.

3. The light-emitting ceiling tile according to claim 1, wherein the ceiling tile comprises a ceiling tile substrate and a light-emitting subassembly disposed on the substrate, the subassembly comprising the group IV nanoparticles.

4. The light-emitting ceiling tile according to claim 3, wherein the ceiling tile substrate comprises two opposing flat faces and a perimeter, and the light-emitting subassembly comprises two opposing flat faces and a perimeter.

5. The light-emitting ceiling tile according to claim 3, wherein the light-emitting subassembly comprises a light-emitting layer, wherein the layer comprises the group IV nanoparticles.

6. The light-emitting ceiling tile according to claim 5, wherein the light-emitting layer comprises a binder for the light-emitting group IV nanoparticles.

7. The light-emitting ceiling tile according to claim 3, wherein the light-emitting subassembly comprises a first electrical insulation layer, a first electrode layer, a light-emitting layer which comprises the light-emitting group IV nanoparticles, a second electrode, and a second electrical insulation layer.

8. The light-emitting ceiling tile according to claim 3, wherein the light-emitting subassembly comprises a first electrical insulation layer, upon which is disposed a first electrode layer, upon which is disposed a light-emitting layer which comprises the light-emitting group IV nanoparticles, upon which is disposed a second electrode, upon which is disposed a second electrical insulation layer.

9. The light-emitting ceiling tile according to claim 7, wherein the first electrical insulation layer and the first electrode layer are substantially transparent to the light emitted by the light-emitting layer.

10. The light-emitting ceiling tile according to claim 1, wherein the tile emits white light.

11. The light-emitting ceiling tile according to claim 3, wherein the light-emitting subassembly comprises an electron barrier layer.

12. The light-emitting ceiling tile according to claim 3, wherein the light emitting subassembly comprises a hole barrier layer.

13. A light-emitting ceiling tile comprising a ceiling tile substrate and a light-emitting subassembly disposed on the substrate, the subassembly comprising light-emitting group IV nanostructures, wherein the ceiling tile substrate comprises two opposing flat faces and a perimeter, and the light-emitting subassembly comprises two opposing flat faces and a perimeter.

14. The light-emitting ceiling tile according to claim 13, wherein the light-emitting subassembly comprises a first electrical insulation layer, upon which is disposed a first electrode layer, upon which is disposed a light-emitting layer which comprises the light-emitting group IV nanostructures, upon which is disposed a second electrode, upon which is disposed a second electrical insulation layer.

15. The light-emitting ceiling tile according to claim 14, wherein the first electrical insulation layer and the first electrode layer are substantially transparent to the light emitted by the light-emitting layer.

16. The light-emitting ceiling tile according to claim 13, wherein the ceiling tile is adapted to provide contact with a voltage source.

17. The light-emitting ceiling tile according to claim 13, wherein the light-emitting subassembly comprises a first electrical insulation layer, a first electrode layer, a light-emitting layer which comprises the light-emitting group IV nanostructures, a second electrode, and a second electrical insulation layer.

18. The light-emitting ceiling tile according to claim 13, further comprising a reflective layer.

19. The light-emitting ceiling tile according to claim 13, further comprising an electron transport layer and a hole transport layer.

20. A subassembly for use in a light-emitting ceiling tile, the subassembly comprising light-emitting group IV nanoparticles

21. The subassembly according to claim 20, wherein the group IV nanoparticles are group IV silicon nanoparticles.

22. The subassembly according to claim 20, wherein the group IV nanoparticles are core-shell nanoparticles.

23. The subassembly according to claim 20, wherein the group IV nanoparticles are core-shell nanoparticle comprising silicon.

24. The subassembly according to claim 20, wherein the subassembly is adapted to be disposed on a ceiling tile substrate.

25. The subassembly according to claim 20, wherein the subassembly comprises two opposing faces and a perimeter edge.

26. The subassembly according to claim 20, wherein the light-emitting subassembly comprises a light-emitting layer, wherein the layer comprises the group IV nanoparticles.

27. The subassembly according to claim 20, wherein the subassembly comprises a binder for the group IV nanoparticles.

28. The subassembly according to claim 20, wherein the subassembly comprises a first electrical insulation layer, upon which is disposed a first electrode layer, upon which is disposed a light-emitting layer which comprises the light-emitting group IV nanoparticles, upon which is disposed a second electrode, upon which is disposed a second electrical insulation layer.

29. The subassembly according to claim 28, wherein the first electrical insulation layer and the first electrode layer are transparent to the light emitted by the light-emitting layer.

30. The subassembly according to claim 20, wherein the sub-assembly emits white light.

31. The subassembly according to claim 20, wherein the sub-assembly emits colored light.

32. A subassembly for use in a light-emitting ceiling tile, the subassembly comprising a first electrode layer, a light-emitting layer which comprises light-emitting group IV nanostructures, and a second electrode layer, wherein the subassembly comprises two opposing faces and a perimeter edge, and wherein the first electrode layer is transparent to the light emitted by the light-emitting layer.

33. The subassembly according to claim 32, wherein the subassembly is adapted to provide contact with a voltage source.

34. The subassembly according to claim 32, wherein the nanostructures are nanoparticles.

35. The subassembly according to claim 32, further comprising a reflective layer.

36. The subassembly according to claim 32, further comprising an electron transport layer and a hole transport layer.

37. The subassembly according to claim 34, further comprising a reflective layer.

38. The subassembly according to claim 34, further comprising an electron transport layer and a hole transport layer.

39. The subassembly according to claim 37, further comprising an electron transport layer and a hole transport layer.

40. A light-emitting ceiling tile device, comprising:
a plurality of nanoparticles, the nanoparticles comprising a group IV semiconductor and a capping agent coupled to the group IV semiconductor, wherein the nanoparticles have an average diameter of between about 0.5 nm to about 15 nm; and
a first electrode electrically coupled to the plurality of nanoparticles; and
a second electrode electrically coupled to the plurality of nanoparticles;
wherein the first and second electrodes together are configured to conduct an applied current to the nanoparticles, wherein the nanoparticles produce light in response to the applied current.

41. The method of making a light-emitting ceiling tile comprising combining a ceiling tile substrate with a light-emitting subassembly comprising light-emitting group IV nanoparticles so that the subassembly is disposed on the ceiling tile substrate.

42. The method of making a light-emitting subassembly comprising combining (a) a light-emitting layer comprising light-emitting group IV nanoparticles, (b) first and second electrode layers, and (c) first and second electrical insulation layers, wherein the layers (a), (b), and (c) are in laminar arrangement, wherein the first electrode is disposed on the first electrical insulation layer, and the first electrode and the first electrical insulation layer are transparent.

43. Use of the ceiling tile according to claim 1 or 13 for emergency lighting.

44. Use of the ceiling tile according to claim 1 or 13 for in-door lighting.

45. Use of the ceiling tile according to claim 1 or 13 for track lighting.

46. Use of the ceiling tile according to claim 1 or 13 for direct lighting of an airplane interior.

47. A light-emitting tile comprising a tile substrate and a light-emitting subassembly disposed on the substrate, the subassembly comprising light-emitting group IV nanostructures, wherein the tile substrate comprises two opposing flat faces and a perimeter, and the light-emitting subassembly comprises two opposing flat faces and a perimeter.

48. The light-emitting ceiling tile according to claim 47, wherein the nanostructures are nanoparticles.

49. The light-emitting tile according to claim 47, wherein the light-emitting subassembly comprises a first electrical insulation layer, a first electrode layer, a light-emitting layer which comprises the light-emitting group IV nanostructures, a second electrode, and a second electrical insulation layer.

50. The light-emitting tile according to claim 49, wherein the first electrical insulation layer and the first electrode layer are substantially transparent to the light emitted by the light-emitting layer.

51. The light-emitting ceiling tile according to claim 47, wherein the tile is adapted to provide contact with a voltage source.
